(19) United States
(12) Patent Application Publication
(10) Pub. No.: US 2014/0378088 A1
(43) Pub. Date: Dec. 25, 2014

(54) Wiretapping Firearms Through a Wireless Network

(71) Applicant: QUALCOMM Incorporated, San Diego, CA (US)

(72) Inventors: Amit Goel, San Diego, CA (US); Srivatsan Veeraraghavan, San Diego, CA (US)

(21) Appl. No.: 13/926,788

(22) Filed: Jun. 25, 2013

(51) Int. Cl. F41A 17/06; H04M 1/02; H04W 4/02; H04M 11/04

(52) U.S. Cl. CPC F41A 17/063; H04M 11/04; H04M 1/0202; H04W 4/02
USPC 455/404.2

(57) ABSTRACT

Methods, systems, and devices for tracking firearms in a wireless communication system may include a firearm configured to send sensor data to a non-recording telephone device via a telephone call to enable a CALEA server to intercept the data via a wiretap. The firearm may include various sensors that collect data about the firearm's location, use, remaining ammo, and any other information regarding its surroundings, which may be sent via the telephone call. A CALEA server may store the firearm data obtained via the wiretap.

### BACKGROUND

Historically, firearm violence has been hard to control, especially in the United States. Firearm violence has caused the injury or death of many individual through school shootings or more commonly through persistent gang wars. Regardless of the source of firearm violence, law enforcement agencies and their corresponding prosecutors have a difficult time prosecuting perpetrators of firearm violence due to limited crime scene evidence. Prosecutors and law enforcement agencies need better tools for collecting accurate evidence at the scene of firearm violence.

### SUMMARY

The various embodiments include methods, firearm devices, and systems configured with processor-executable instructions to collect data regarding the location and use of firearms, encrypt the data, and anonymously transmit the data through a cellular telephone network from a firearm to a non-recording telephone device. Transmitting the collected data via a telephone call enables authorized law enforcement to acquire the data via a legal wiretap. Sending the collected data to a non-recording telephone device ensures that the data is not recorded for unauthorized or unlawful purposes.

In an embodiment, a firearm may include a cellular telephone transceiver, a location sensor, a use sensor, and a processor coupled to the cellular telephone transceiver, the location sensor, and the use sensor, where the processor is configured to place a cellular telephone call with a non-recording telephone device and transmit without a user's knowledge at least one of the location of the firearm and a use of the firearm through a cellular telephone network to the non-recording telephone device. In a further embodiment, the firearm may include a plurality of additional sensors configured to collect information regarding its status, ammunition level, video, audio, aiming direction, environment, a user's heart rate, etc., and the firearm may transmit the additional data through the cellular telephone network to a receiving device such as the non-recording telephone device. In a further embodiment, the firearm may include a camera, and the system may transmit a video stream through the cellular telephone network to the network destination.

An embodiment method implemented on a firearm with a wireless communication circuit may include acquiring data including the location and use of the firearm, determining whether a wireless data communication link is available, storing the acquired data in memory in response to determining that a wireless data communication link is not available, placing a telephone call to a non-recording telephone device and transmitting the acquired data and the stored data in the memory via the telephone call in response to determining that a wireless data communication link is available. In a further embodiment, the method may include encrypting the acquired data prior to transmitting it to the non-recording telephone device in the telephone call.

In an embodiment, a Communications Assistance for Law Enforcement Act (CALEA) server may be configured to receive, without a firearm user's knowledge, at least one of a location of the firearm and a use of the firearm while the firearm is transmitting data by a telephone call through a wireless telecommunications network to a non-recording telephone device. In an embodiment, a network server may add an opaque marker to the call originating from the selected firearm to the non-recording telephone device to mask the identity of the firearm user. In an embodiment, the network server may receive the call from the selected firearm and determine whether the call is marked for CALEA forwarding. In an embodiment, the network server may transmit a copy of the phone call and the associated sensor data (e.g., location, use, status, ammunition level, video, audio, aiming direction, environment, a user's heart rate, etc.) to the CALEA server when the call is marked for forwarding to the CALEA server. In an embodiment, the network server may end the call between the selected firearm and the non-recording telephone device to conserve battery power on the selected firearm. In an embodiment, the CALEA server may be configured to receive sensor data from the firearm through the cellular telephone network by intercepting the communication between the firearm and the non-recording telephone device. In a further embodiment, the server may be configured to receive a video stream through the cellular telephone network, store the video stream in a memory, and output the video stream for viewing.

An embodiment method implemented at a CALEA server and/or the network server may include selecting a firearm from a plurality of firearms, initiating or accessing a legal wiretap of calls to/from the selected firearm, adding an opaque marker to the call originating from the selected firearm, receiving a call from the selected firearm, determining whether the call is marked for CALEA forwarding, transmitting a copy of the phone call and the associated data to the CALEA server while transmitting the same to a non-recording telephone device in response to determining that the call is marked for CALEA forwarding, ending the call/call attempt between the firearm and the non-recording telephone device in response to determining that the call is not marked for CALEA forwarding, receiving the firearm use data transmission by the selected firearm in telephone calls via the legal wiretap. In an embodiment, the CALEA server may decrypt the received firearm data. In a further embodiment, the CALEA server may store the firearm data for future use.

In an embodiment, a firearm may include means for acquiring data related to the firearm including a location and a use of the firearm, means for determining whether a cellular telephone call may be established, means for storing the acquired data in memory in response to determining that a cellular telephone call cannot be established, and means for placing a cellular telephone call to a non-recording telephone device and transmitting the acquired data and data stored in the memory via the cellular telephone call in response to determining that a cellular telephone call can be established. In embodiment, the firearm may include means for encrypting the acquired data prior to transmitting the acquired data to the non-recording telephone device via the cellular telephone call.

An embodiment includes a non-transitory processor-readable storage medium having processor-executable instructions stored thereon that are configured to cause a processor of a firearm to perform operations including acquiring data related to the firearm including a location and a use of the firearm, determining whether a cellular telephone call may be established, storing the acquired data in memory in response to determining that a cellular telephone call cannot be established, and placing a cellular telephone call to a non-recording telephone device and transmitting the acquired data and data stored in the memory via the cellular telephone call in response to determining that a cellular telephone call can be established. In embodiment, the stored processor-executable instructions may be configured to cause the processor of the firearm to perform operations further including encrypting the firearm processor acquired data prior to transmitting the acquired data to the non-recording telephone device via the cellular telephone call.

In an embodiment, a cellular communication system may include a firearm with a cellular telephone transceiver, a location sensor, a use sensor, and a firearm processor coupled to the cellular telephone transceiver, the location sensor, and the use sensor. In this embodiment, the firearm processor is configured with processor-executable instructions to perform operations including acquiring sensor data from the location sensor and the use sensor, determining whether a cellular telephone call can be established, storing the acquired sensor data in memory of the firearm in response to determining that a cellular telephone call cannot be established, and placing a cellular telephone call from the firearm cellular telephone transceiver to a non-recording telephone device and transmitting the acquired sensor data and sensor data stored in the memory via the cellular telephone call in response to determining that a cellular telephone call can be established. In an embodiment, the cellular communication system may include a CALEA server configured with processor-executable instructions to perform operations including initiating a wiretap on the firearm using a telephone number of the firearms' cellular telephone transceiver, and receiving through the wiretap the sensor data sent from the firearm to the non-recording telephone device via the cellular telephone call. In an embodiment, the cellular communication system may include a network server configured with processor-executable instructions to perform operations including adding an opaque marker to the cellular telephone call originating from the firearm, determining whether the cellular telephone call from the firearm is marked for CALEA forwarding, and transmitting a copy of the sensor data sent from the firearm to the non-recording telephone device via the cellular telephone call to the CALEA server in response to determining that a cellular telephone call is marked for CALEA forwarding, and ending the cellular telephone call and data transmission to the non-recording telephone device in response to determining that a cellular telephone call is not marked for CALEA forwarding. In an embodiment, the network server may be configured with processor-executable instructions to perform operations further including transmitting the cellular telephone call and the acquired sensor data to a network destination in response to determining that a cellular telephone call is not marked for CALEA forwarding. In a further embodiment, the firearm processor may be configured with processor-executable instructions to perform operations including encrypting the acquired sensor data and the sensor data stored in the memory prior to transmission via the cellular telephone call. In an embodiment, the CALEA server may be configured with processor-executable instructions to perform operations including decrypting the sensor data obtained from the firearm via the wiretap and storing the sensor data from the firearm.

In an embodiment, a cellular communication system may include a firearm with means for acquiring sensor data from the location sensor and the use sensor, determining whether a cellular telephone call can be established, means for storing the acquired sensor data in memory of the firearm in response to determining that a cellular telephone call cannot be established, means for placing a cellular telephone call from the firearm cellular telephone transceiver to a non-recording telephone device and transmitting the acquired sensor data and sensor data stored in the memory via the cellular telephone call in response to determining that a cellular telephone call can be established. In an embodiment, the cellular communication system may include a CALEA server with means for initiating a wiretap on the firearm using a telephone number of the firearm's cellular telephone transceiver, and means for receiving through the wiretap the sensor data sent from the firearm to the non-recording telephone device via the cellular telephone call. In an embodiment, the cellular communication system may include a network server with means for adding an opaque marker to the cellular telephone call originating from the firearm, means for determining whether the cellular telephone call from the firearm is marked for CALEA forwarding, means for transmitting a copy of the sensor data sent from the firearm to the non-recording telephone device via the cellular telephone call to the CALEA server in response to determining that a cellular telephone call is marked for CALEA forwarding, and means for ending the cellular telephone call and data transmission to the non-recording telephone device in response to determining that a cellular telephone call is not marked for CALEA forwarding. In an embodiment, the network server may include means for transmitting the cellular telephone call and the acquired sensor data to a network destination in response to determining that a cellular telephone call is not marked for CALEA forwarding. In a further embodiment, the firearm may include means for encrypting the acquired sensor data and the sensor data stored in the memory prior to transmission via the cellular telephone call. In an embodiment, the CALEA server may include means for decrypting the sensor data obtained from the firearm via the wiretap and means for storing the sensor data from the firearm.

### BRIEF DESCRIPTION OF THE DRAWINGS

The accompanying drawings, which are incorporated herein and constitute part of this specification, illustrate exemplary embodiments of the invention, and together with the general description given above and the detailed description given below, serve to explain the features of the invention.

FIG. 1A is a communication system block diagram illustrating network components of an example telecommunication system suitable for use in the various embodiments.

FIG. 1B is a communication system block diagram illustrating a CALEA server tapping a telephone call of a firearm.

FIG. 2 is an illustration of an example firearm suitable for use in various embodiments.

FIG. 3 is a component block diagram of a firearm suitable for use in various embodiments.

FIG. 4 is a process flow diagram illustrating an embodiment method for a firearm to collect and transmit data in a manner that enables the data to be wiretapped.

FIG. 5 is a process flow diagram illustrating an embodiment wiretapping method at a remote server.

FIG. 6 is a component block diagram of a server device suitable for use in an embodiment.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

The word “exemplary” is used herein to mean “serving as an example, instance, or illustration.” Any implementation described herein as “exemplary” is not necessarily to be construed as preferred or advantageous over other implementations.

Current wiretapping solutions of mobile devices for law enforcement work through the telecommunications carriers and utilize some of the technologies described above. The Communications Assistance for Law Enforcement Act (CALEA) is a wiretapping law signed by president Bill Clinton in 1994 and requires telecommunication carriers to contemporaneously isolate and intercept all call-identifying information that is reasonably available in the network. Telecommunication providers must isolate and intercept calls of a particular subject and deliver intercepted content and call-identifying information to a particular law enforcement agency. CALEA has been of enormous help to law enforcement agencies as it has enabled them to seamlessly and remotely tap into phone conversations.

CALEA requires wiretap solutions to be implemented on the telecommunications network for law enforcement agencies. Thus, when mobile phones or traditional landline phone make telephone calls, law enforcement personnel authorized by a warrant may intercept that phone without the caller or the call receiver knowing call. Actual implementations of CALEA, such as the call interception point, may vary based on the service provider, the type of data, or phone call being conducted.

CALEA is designed to intercept the communication between two devices, such as a phone call between two mobile phones or the transmission of a text message between a mobile phone and a computer. Thus, devices (e.g., firearms) that are not inherently communication devices are beyond the reach of CALEA methods.

The various embodiments collect location and usage data on a firearm and then cause the firearm to send that data via a telephone call that can be wiretapped by law enforcement using the CALEA system. To ensure the owner's privacy is not invaded and to ensure the firearm data is only accessed by law enforcement with a warrant, the embodiments include the firearm placing a call to or receiving a call from a non-recording telephone device, like an automatic answering machine that does not record the call or a server that just maintains the telephone call without recording data. Such a non-recording telephone device may receive a phone call from or start a phone call with a firearm. During the active phone call between the firearm and the non-recording telephone device, law enforcement agencies may use CALEA wiretap solutions to intercept the phone call and record any information transmitting from the firearm. Implementing wireless technology on firearms to enable wiretapping by the CALEA system may enable law enforcement personnel to obtain data from the firearms on the existing telecommunications networks necessary to prevent and prosecute crimes involving firearms.

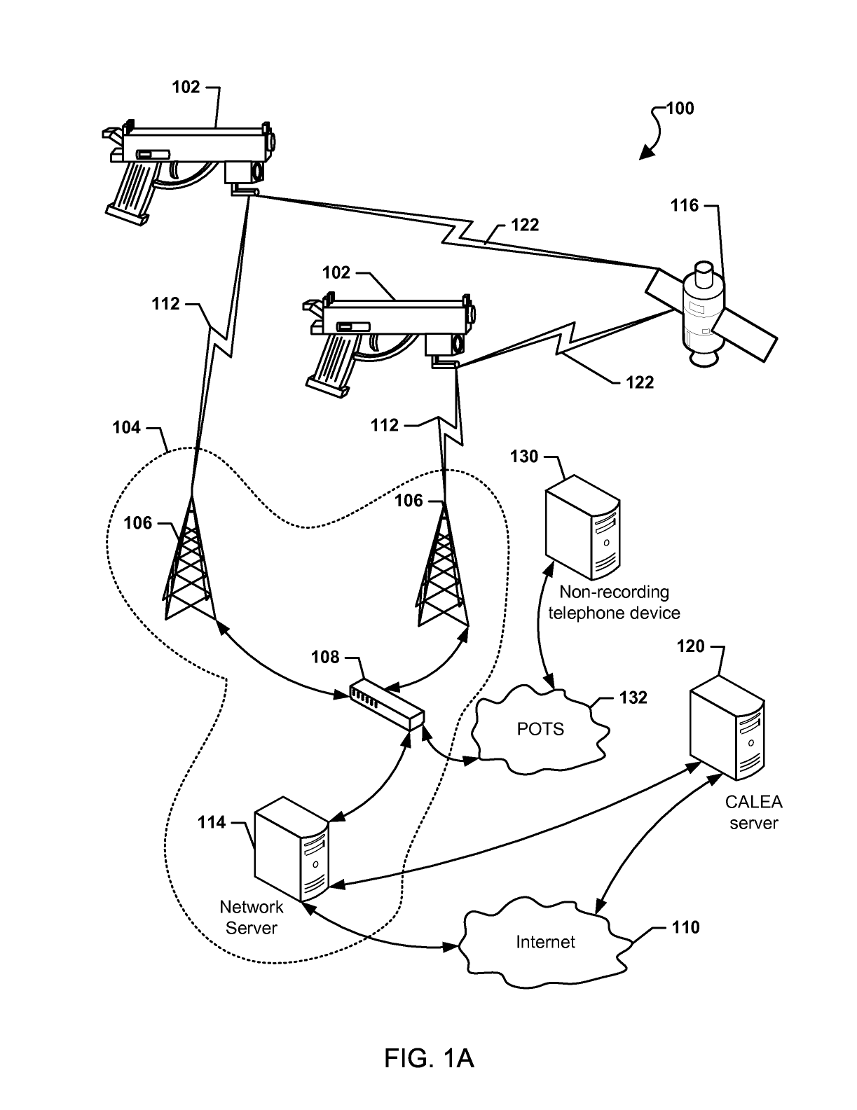

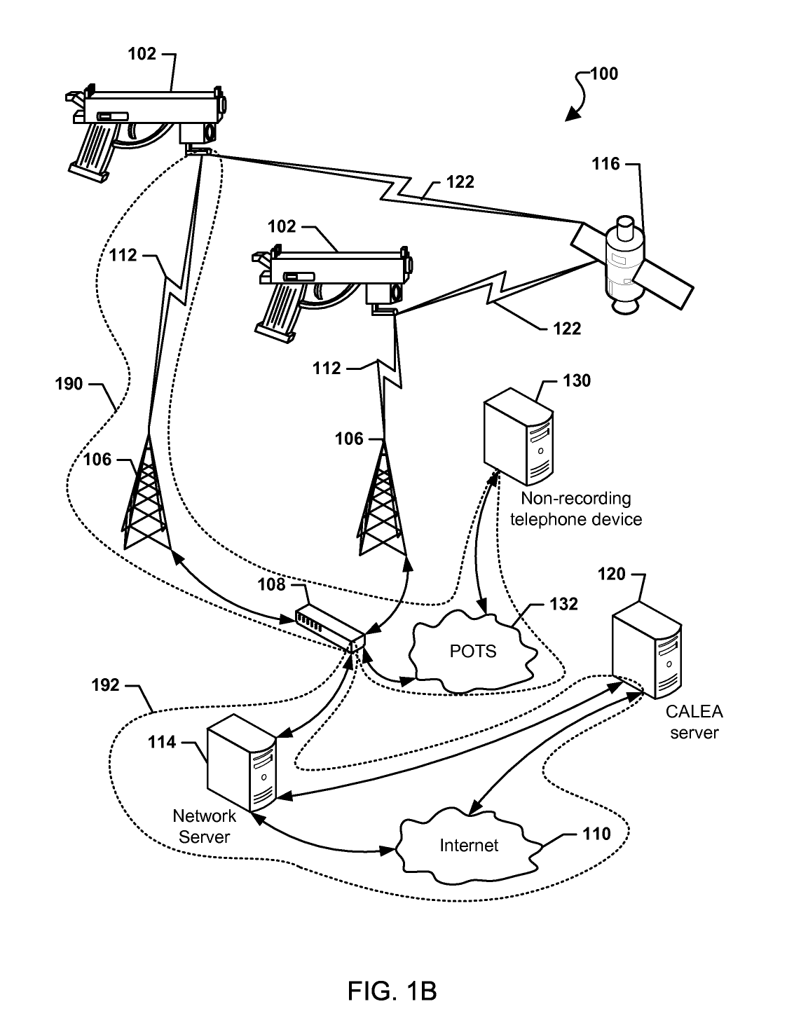

The various embodiments may be implemented within a variety of communication systems, such as a cellular telephone network, an example of which is illustrated in FIG. 1A. A typical cellular telephone network 104 includes a plurality of cellular base stations 106 coupled to a network operations center 108, which operates to connect data transmissions between mobile phones (not shown), firearms 102, a Plain Old Telephone Service (POTS) 132, a non-recording telephone device 130, the Internet 110, and other network destinations. Communications between the firearms 102 and the cellular telephone network 104 may be accomplished via two-way cellular telephone communication links 112, such as 4G, 3G, CDMA, TDMA, and other cellular telephone communication technologies. The cellular telephone network 104 may also include one or more servers 114 coupled to or within the cellular telephone network 104 that provide connections to the Internet 110, and/or are used to perform various operations, such as storing and maintaining network information or removing background noises. The firearms 102 may receive geo-spatial positioning signals 122 from navigation satellites 116 (e.g., Global Positioning System (GPS) satellites) and use the received signals to identify their geographic positions. The one or more network servers 114 may be coupled to a CALEA server 120, which may receive data from wiretaps supported by the network. The CALEA server may intercept data transmission between a firearm 102 and the non-recording telephone device 130 through the CALEA architecture. The CALEA server may store received data from the firearms 102 for law enforcement purposes.

FIG. 1B illustrates a phone call 190 from the firearm 102 to the non-recording telephone device 130. As with any cellular telephone call, the firearm 102 may connect wirelessly to the cellular base station 106 through a two-way cellular telephone communication link 112. The cellular base station 106 may connect the network operations center 108, which may connect to the POTS network 132 that connects the call to the non-recording telephone device 130. The non-recording telephone device 130 may answer the call from the firearm 102 and keep the line open as long as the firearm remains on the line without saving the data.

The CALEA server 120 may initiate a wiretap 192 by following CALEA procedures, such as upon obtaining a warrant, command a network server to download all communications from calls from/to an identified telephone number of the firearm. Thus, when the firearm 102 is making the phone call 190 to the non-recording telephone device 130, the CALEA server 120 may intercept the phone call via the CALEA wiretap 192. Under CALEA, the CALEA server 120 may tap a phone call from the firearm 102 to the non-recording telephone device by a series of connections to the network operations center 108. For example, the CALEA server 120 may connect to the network operations center 108 through the network server 114. In another example, the CALEA server 120 may connect to the network operations center 108 through the internet 110 and the network server to intercept the firearms' phone calls. In alternative embodiments, the CALEA server 120 may initiate a tap at the network server through POTS 132, directly at the non-recording telephone device, or at any location in between the phone call of the firearm and the non-recording telephone device. These types of wireless wiretaps allow a law enforcement agency to intercept the phone call from the firearm using existing CALEA complaint network architecture imposed on the telecommunication carriers.

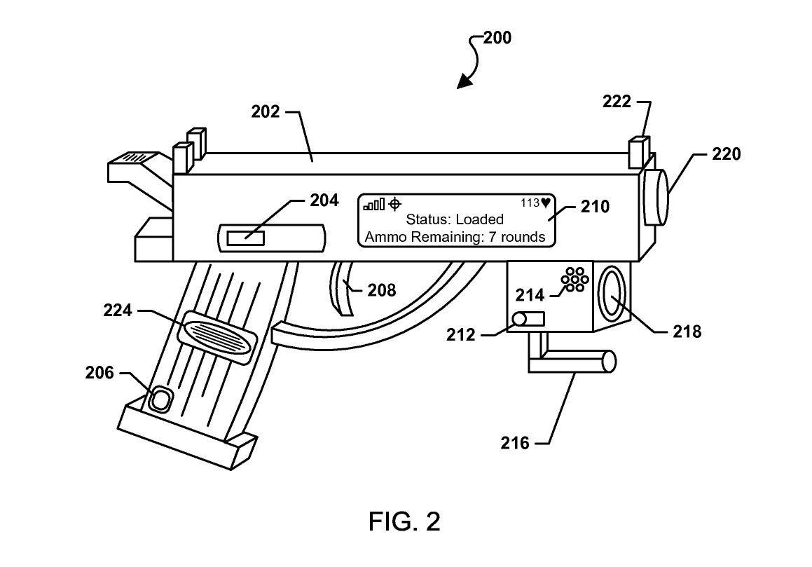

FIG. 2 illustrates an example firearm suitable for use in the various embodiments. The firearm 202 may have a safety mechanism 204 connected to the trigger 208, which may provide a mechanical lock to prevent the trigger from moving and firing the weapon. The safety mechanism may also include an electrical component that may sense the position of the safety mechanism, which may allow the firearm and an associated processor to determine the firearm's status. The firearm 202 may have a camera 218 with the ability to take photos and video of the nearby area. In an embodiment, the camera 218 may be mounted on the weapon in such a way that it can record video, stills, or light fields in the same direction of the firing weapon. The firearm 202 may have a standard aiming mechanism 222 with the enhancement of an electronic direction detector that detects the direction the firearm is pointing in x, y, and z planes. The firearm may also have a microphone 214 for recording audio in the vicinity of the firearm, such as a user's audio notes or sounds of an active crime scene. The firearm barrel 220 may include a firing detector to sense when the firearm has discharged a bullet. The firearm may also have an ammunition detector 206 that detects and records the number of rounds of ammunition remaining. The firearm 202 may include an environment sensor 212, which may record the temperature, humidity, barometric pressure, or any other environmental condition. The firearm may also include a heartbeat sensor 224, which may detect when a user is holding the weapon. The heartbeat sensor 224 may be located on the butt or grip of the weapon or any other practical location so that it may detect the heartbeat of the user. The firearm may include an antenna 216 coupled to a cellular telephone transceiver or airlink modem to allow the firearm to connect to a cellular telephone network (e.g., cellular, satellite, WiFi, etc.).

The firearm 202 may have a display 210, which may indicate the current location of the device, the remaining rounds of ammunition in its magazine from the ammunition detector 206, or any other information from the various sensors on the firearm. As illustrated, the display 210 may show that is it connected to a cellular telephone network to allow for the remote transmission of data. This may be illustrated similar to a mobile phone where bars increasing in height may indicate the signal strength of the wireless connection. When a GPS location has been obtained through a location sensor, an indicator, such as a target (e.g., a circle with a cross), may be displayed, such as in the corner of the display. Also as illustrated, the display 210 may show the user's heart rate (displayed as “113 ♡”).

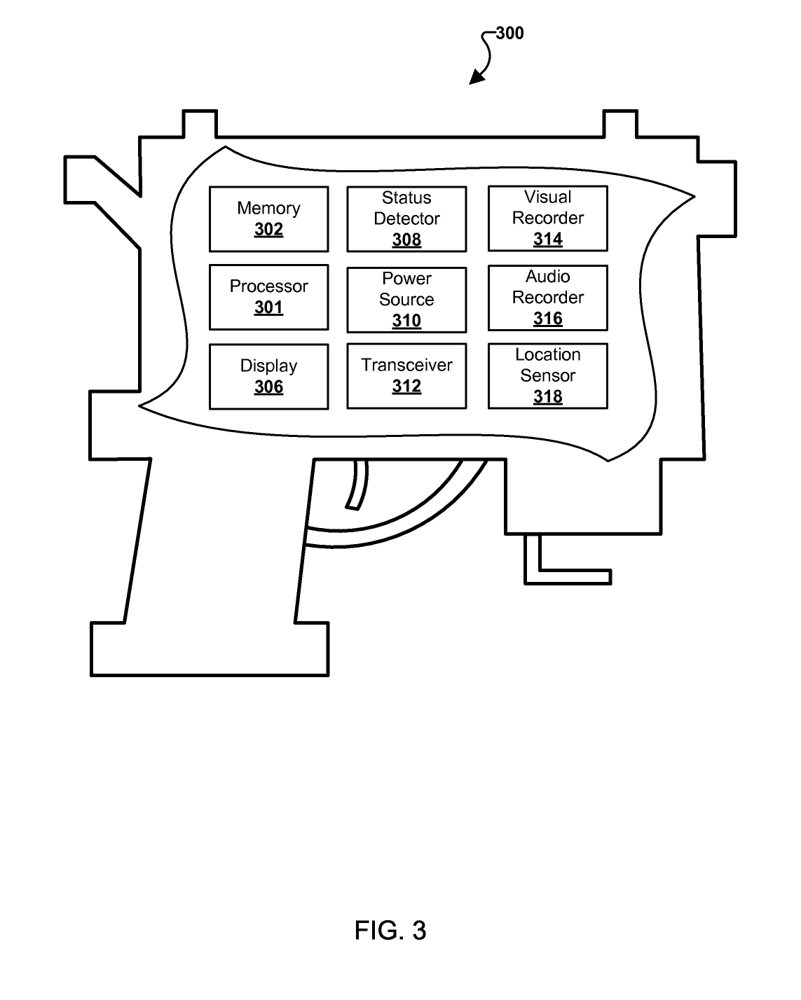

FIG. 3 illustrates components of a firearm 300 suitable for use in the various embodiments. The firearm 300 may include a processor 301 coupled to the memory 302, which may store data collected from the various firearm sensors 308, 314, 316, 318. The memory 302 may have a secure portion that is unalterable by the user of the firearm for storing information that may be transmitted by a telephone call via a wireless transceiver 312 over a cellular telephone network. The firearm 300 may include a power source (e.g., a battery) to power the various sensors, the processor, and other components.

The status detector 308 may detect a number of states or changes to the firearm. For example, the status detector 308 may track the rounds of ammunition remaining in the firearm. The status detector 308 may sense when ammunition (e.g., a bullet) is loaded into the chamber of the firearm, when the firearm is reloaded and/or when the safety is off. The status detector may also detect when a user is holding the firearm such as the heartbeat sensor 224.

A video camera 314 may be any photo or video recording device. For example, the video recorder may include a light field recorder, a video recorder, or a still picture camera. The video camera 314 may be mounted on the front of the firearm as shown in FIG. 2. In an embodiment, the video recorder may be manually turned on and off by the user. In an alternative embodiment, the video recorder may be automatically turned on once the firearm is active as determined by the processor 301. For example, the processor 301 may determine that the firearm is active when the status detector detects that a round of ammunition entered the firing chamber of the weapon. The processor may signal to the video camera 314 to activate and start recording video.

In a similar fashion, the firearm may include an audio recorder 316 that may record sounds. The audio recorder may be a microphone located at the end of the firearm as illustrated in FIG. 2.

The firearm may include a location sensor 318 that may record, send, and receive location information regarding the position of the firearm, whether the firearm is moving, and how fast the firearm is moving.

The firearm may include a transceiver 312 that may connect to a cellular telephone network (e.g., LTE, GSM, UMTS, and CDMA). Through the cellular telephone network, the firearm transceiver may transmit/receive any available data through a phone call between firearms, a non-recording telephone device, or any other device. The firearm may transmit through the transceiver 312 and the cellular telephone network any and all available sensor data to the non-recording telephone device such as the firearm's current ammunition level, location, video, audio, or any other data that the firearm may have.

In an embodiment, the firearm may provide no indication that it is communicating with a cellular telephone network. In this manner, the user is never aware when law enforcement may be wiretapping the firearm.

In another embodiment, the firearm may include a display 306 that may display any information from the various sensors. For example, users of the firearm may be law enforcement personnel who want to connect to a cellular telephone network. The display 306 may indicate that the firearm is connected to a cellular telephone network as shown by the four escalating bars on the display 210 in FIG. 2. The law enforcement personnel may want to alert other nearby law enforcement personnel of his ammunition status or whether his firearm was fired by connecting his firearm to other devices and firearms through a cellular telephone network and transmitting the appropriate data. Nearby law enforcement personnel may locate the fired weapon and provide strategic back-up based on the real-time information received from the connected weapon. The display may also provide the law enforcement user with a visual representation of the remaining number of bullets in the weapon as well as a visual indication of whether the weapon is loaded or jammed.

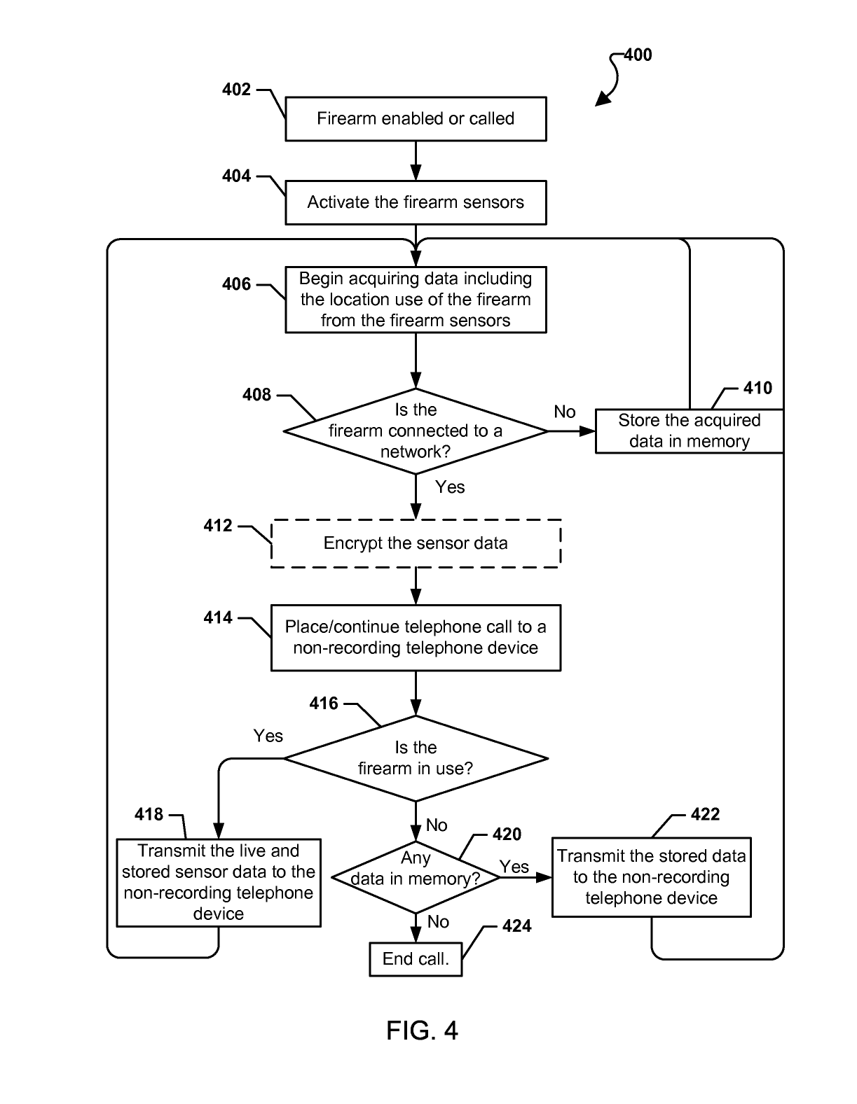

As mentioned above, by transmitting information gathered by the various sensors on the firearm to any telephone device via a cellular telephone network, the embodiments enable a communication that law enforcement can then intercept via CALEA wiretap methods. FIG. 4 illustrates an embodiment method 400 that may be implemented on a firearm to enable law enforcement to conduct such a wiretap. The method 400 may be initiated when a user enables the firearm, the firearm periodically wakes up, or a call is received by the firearm in block 402. Enabling the firearm may include, but is not limited to, a user pressing a button (e.g., a button labeled “On”), toggling a switch, disengaging the safety, or simply pressing the user's hand against a heartbeat sensor on the firearm. In an embodiment, the firearm may include a motion sensor, and may enable itself in response to detecting movement.

In another embodiment, the firearm processor may be configured to periodically wake up in block 402 to perform the method 400, such as daily, weekly or monthly. Periodically enabling the firearm may allow the processor to place a call that can be detected in a wiretap to report minimal sensor data, such as its current location and state.

In yet a further embodiment, in block 402 the firearm may be configured to receive and answer a call, such as from the non-recording telephone device, with the reception of such a call initiating the method 400 for acquiring and transmitting data. In an embodiment, the firearm may not answer the incoming call, but instead place a new call to the non-recording telephone device in response to detecting the incoming call. As described below, this capability may enable law enforcement to prompt the firearm to initiate and/or conduct a telephone call and transmit data so that the data can be acquired via a CALEA wiretap.

Even when the firearm is enabled, the sensors may not be fully active. This may allow the firearm to conserve battery power. Upon various trigger events, in block 404, the firearm may activate one or more of its sensors. As discussed above, the firearm may have a number of different sensors including a heartbeat sensor, ammo sensor, gyroscope, directional sensor, location transceiver, audio recorder, video recorder, etc. All of these sensors may be activated or they may be individually activated based on a given situation, location, operating state, or user setting. For example, a firearm may record video only during the day due light requirements of the video recorder. As another example, the firearm may record video and audio when it determines that is located in a populated area, but only ammunition and usage states when it is located in remote location where hunting is authorized. In this manner, the firearm may conserve battery power by activating only those sensors that may provide relevant information to law enforcement based on the circumstances. In block 406, the firearm begins acquiring sensor data from its activated sensors.

In determination block 408, the firearm may determine whether it is connected to a cellular telephone network. While making the determination, the firearm may consider the signal strength connected to a network (e.g., cellular signal). In an embodiment, the firearm may determine that a low cellular signal is the equivalent of not being connected to a network. This may allow the firearm to conserve battery power instead of increasing the power and strength of its transmit and receive signals in an attempt to obtain a better wireless connection. When the processor of the firearm determines that the firearm is not connected to a cellular telephone network (i.e., determination block 408=“No”), the firearm may store the acquired data in memory in block 410 and continue acquiring sensor data in block 406. The processor of the firearm may be configured to periodically check the firearm's connectivity to a cellular network, storing acquired sensor data so long as a connection is not available, and placing a call when cellular network connectivity becomes available.

When the processor of the firearm determines that it is connected to a cellular telephone network (i.e., determination block 408=“Yes”), in optional block 412, the firearm may encrypt the sensor data. The sensor data may be encrypted to prevent unauthorized access of the firearm data transmission from crime syndicates, foreign governments, or other criminals. In an embodiment, the data may be encrypted using a method and cipher known to law enforcement so the data can be decrypted when obtained by a wiretap. In an embodiment, the firearm may not encrypt its data to allow easy wiretapping for the CALEA server.

In block 414, the processor of the firearm may place a telephone call to a non-recording telephone device through a cellular telephone transceiver. The non-recording telephone device may automatically answer the phone call without recording the data. By establishing such a call through a telephone network, information transmitted during the call is made available for wiretapping by law enforcement via the CALEA architecture and procedures. In an embodiment, the processor of the firearm may place a data session call to a uniform resource locator (“URL”). Similar, to the non-recording telephone device, the URL may not record the data session call, but will automatically answer a call from the firearm or call the firearm if requested to do so.

In determination block 416, the processor of the firearm may determine whether it is in use. For example, if the firearm has a heartbeat monitor, the processor may receive a signal from the heartbeat monitor and determine whether the firearm is being held based upon whether a heartbeat is detected (indicating the firearm is being held) or not. In another example, if the firearm has a firing discharge sensor the processor may determine that the firearm is in use when the firing discharge sensor is triggered (e.g., a shot is fired). As another example, if the firearm has a motion sensor (e.g., an accelerometer), the processor may determine that the firearm is in use when signals from the motion sensor indicate significant movement. As another example, the processor of the firearm may determine that the firearm is in use when the firearm is loaded (e.g., a bullet is located in the firing chamber of the firearm). As another example, the processor of the firearm may determine that the firearm is in use when the firearm is reloaded (e.g., a new magazine is replaced). As an opposite example, the processor of the firearm may determine that the firearm is not in use when the safety is on (i.e., the trigger is locked). In another opposite example, the processor of the firearm may determine that the firearm is not in use when the ammo sensor senses that the magazine is empty.

If the firearm determines that it is in use (i.e., determination block 416=“Yes”), the processor may transmit acquired and any stored sensor data (e.g., live data and cached data) to the non-recording telephone device through the established telephone call in block 418. The transmission of data may be wiretapped and recorded by the CALEA server during the firearm's transmission since the data is being transmitted via a telephone network. In an embodiment, the firearm may transmit the acquired and stored sensor data to a network destination such as a URL through a data session call. In this embodiment, the CALEA server may wiretap and record the data call to the URL without the firearm or the user of the firearm being aware.

If the firearm determines that it is not in use (i.e., determination block 416=“No”), the firearm processor may determine whether there is any sensor data stored in memory to transmit in determination block 420. If so, (i.e., determination block 420=“Yes”), the firearm processor cause the firearm to transmit the stored or cached sensor data to the non-recording telephone device during the telephone call in block 422. In an embodiment, the firearm may transmit the stored sensor data to a network destination such as a URL through a data session call that automatically answers a call from the firearm or calls the firearm if requested to do so. Similar to block 418, the CALEA server may wiretap and record the data call without the firearm or the user of the firearm being aware. In an embodiment, the firearm may transmit live and stored sensor data (as in block 418) or only stored sensor data (as in block 422) to the designated location with a built-in modem in the firearm that transmits data over the phone lines to the non-recording telephone device with a modem on the receiving side. In an alternative embodiment, the firearm may transmit sensor data to a network destination, such as a URL, with wireless modem technologies such as 3G, 4G, LTE, etc., and the network destination may receive the transmitted data, which may be intercepted by the CALEA server. In order to protect the user's privacy rights, the processor may also delete data from the memory once it has been transmitted as part of the operations in blocks 418 and 422. The operations of acquiring sensor data and transmitting sensor data may continue via the established telephone call so long as the firearm is in use and/or there is data stored in memory to be transmitted. When the processor determines that the firearm is no longer in use and all cached data has been transmitted (i.e., determination block 416=“No” and determination block 420=“No”), the firearm processor may end the telephone call in block 424.

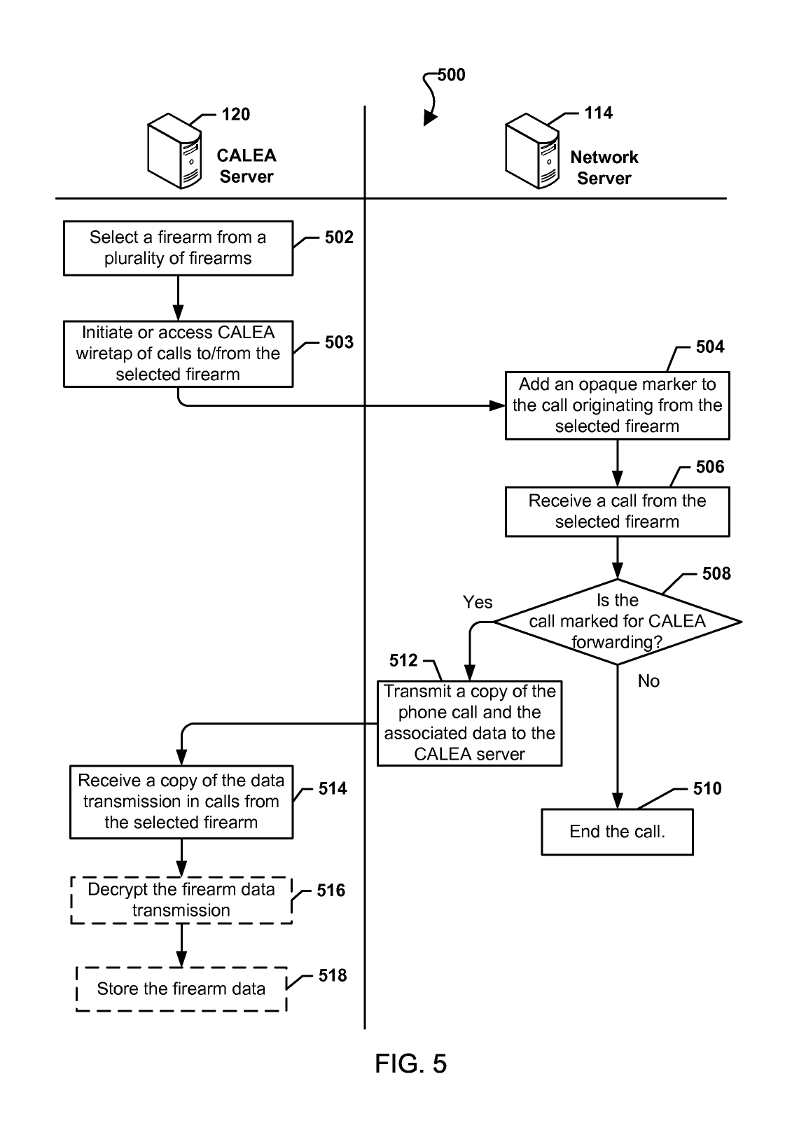

FIG. 5 is a process flow diagram illustrating an embodiment method 500 of wiretapping a firearm from a remote server, such as a CALEA server 120 as well as the interactions between the CALEA server and a network server 114. In block 502, the CALEA server may select a network identifier or telephone number of a firearm from a plurality of firearms. In an embodiment, the CALEA server may maintain a database of telephone numbers (or other network identifier) of firearms configured with the features described herein. If there is a particular firearm that the law enforcement personnel (with appropriate court orders) want to actively track or wiretap, the CALEA server may be able to select that particular firearm from the database and obtain its telephone number or network identifier. In block 503, the CALEA server may use the obtained firearm telephone number or network identifier to initiate a wiretap on the selected firearm using standard CALEA processes. This process may involve the CALEA server sending the obtained firearm telephone number or network identifier to the network servers 114 configured to initiate a CALEA wiretap. As provided in the CALEA processes, no individual in the telephone networks may be aware that such a wiretap has been initiated.

In block 504, the network server may add an opaque marker to the call originating from the selected firearm. The opaque marker may allow the data to be associated with a particular device without disclosing the owner of the device or other data necessary to connect the individual user of the gun to the call.

In block 506, the network server may receive a call from the selected firearm. The selected firearm may call the network server according to the method described above with reference to FIG. 4. In an embodiment, the firearm may have network connectivity and call a non-recording telephone device through the network server 114.

In determination block 508, the network server may determine whether the received call is marked for CALEA forwarding. If the network determines that the call is marked for CALEA forwarding (i.e., determination block 508=“Yes”), in block 512, the network server may transmit a copy of the phone call and associated data to the CALEA server while transmitting the call and the associated data to the non-recording telephone device. If the network determines that the call is not marked for CALEA forwarding (i.e., determination block 508=“No”), in block 510, the network server may end the call attempt to the non-recording telephone device. Since the purpose of the non-recording telephone device is to automatically answer telephone calls from the firearm to enable a CALEA wiretap, there may not be a need to continue the call to the non-recording telephone device allowing the firearm to conserve battery power by ending the call and data transmission. However, in an embodiment, if the call is not marked for CALEA forwarding, the network server may continue the call and data transfer to the non-recording telephone device without transmitting a copy of the call and the associated data to the CALEA server. In a similar embodiment, if the firearm is calling another device, such as another firearm or a network destination, the network server may continue transmitting the call and the associated data to the other device without forwarding the call and the associated data to the CALEA server unless the call is marked for CALEA forwarding.

In block 514, the CALEA server may receive a copy of the data transmission associated with the calls from the selected firearm to the non-recording telephone device (or other designated network destination). In an embodiment, the CALEA server may simultaneously stream the information or forward the incoming call data to another device, such as a law enforcement personnel's mobile device through a telecommunication network.

In optional block 516, the CALEA server may decrypt the firearm data if the data is being transmitted in encrypted format. In an embodiment, all firearm data transmission may be encrypted to prevent unauthorized parties from obtaining tracking data of the firearms. The CALEA server may have a decryption key to allow it to decrypt the data from the selected firearm or all firearms.

In optional block 518, the CALEA server may store the firearm data for later use or presentation. For example, the CALEA server may store in a database any data received through its wireless wiretap of a firearm for use in investigations and subsequent criminal prosecutions.

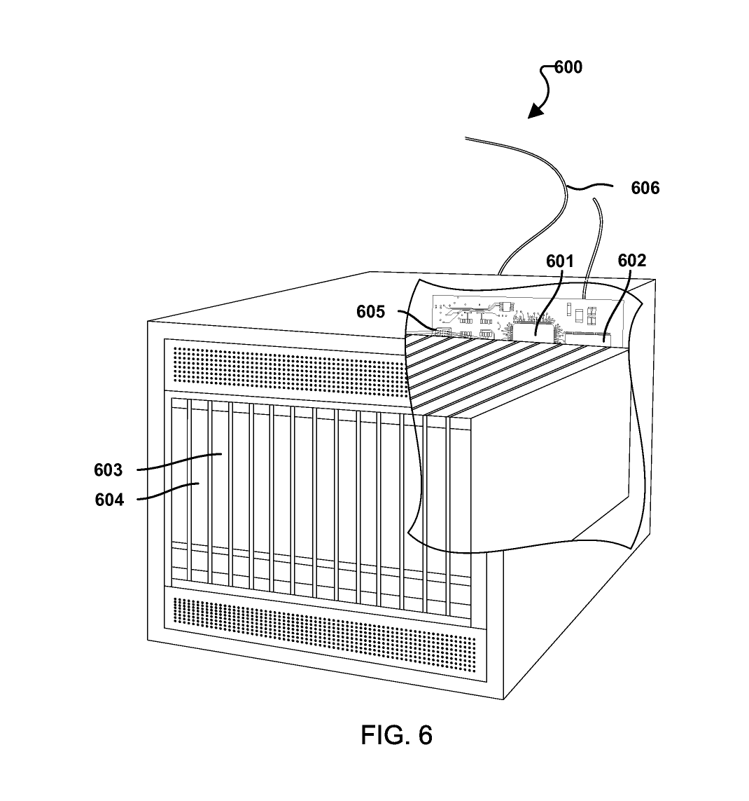

Portions of the embodiment methods may be accomplished in a CALEA server architecture with some of the processing occurring in a server, such as maintaining databases of normal operational behaviors. Such embodiments may be implemented on any of a variety of commercially available server devices, such as the server 600 illustrated in FIG. 6. Such a server 600 typically includes a processor 601 coupled to volatile memory 602 and a large capacity nonvolatile memory, such as a disk drive 603. The server 600 may also include a floppy disc drive, compact disc (CD) or digital versatile disc (DVD) disc drive 604 coupled to the processor 601. The server 600 may also include network access ports 605 coupled to the processor 601 for establishing data connections with a network 606, such as a local area network coupled to other broadcast system computers and servers.

The processors 301, 601 may be any programmable microprocessor, microcomputer or multiple processor chip or chips that can be configured by software instructions (applications) to perform a variety of functions, including the functions of the various embodiments described below. In some firearms, multiple processors 301 may be provided, such as one processor dedicated to wireless communication functions and one processor dedicated to running other applications. Typically, software applications may be stored in the internal memory 302, 602, 703 before they are accessed and loaded into the processor 301, 601. The processor 301, 601 may include internal memory sufficient to store the application software instructions.

The foregoing method descriptions and the process flow diagrams are provided merely as illustrative examples and are not intended to require or imply that the steps of the various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

As used in this application, the terms “component,” “module,” “system,” “engine,” “generator,” “manager” and the like are intended to include a computer-related entity, such as, but not limited to, hardware, firmware, a combination of hardware and software, software, or software in execution, which are configured to perform particular operations or functions. For example, a component may be, but is not limited to, a process running on a processor, a processor, an object, an executable, a thread of execution, a program, and/or a computer. By way of illustration, both an application running on a computing device and the computing device may be referred to as a component. One or more components may reside within a process and/or thread of execution and a component may be localized on one processor or core and/or distributed between two or more processors or cores. In addition, these components may execute from various non-transitory computer readable media having various instructions and/or data structures stored thereon. Components may communicate by way of local and/or remote processes, function or procedure calls, electronic signals, data packets, memory read/writes, and other known network, computer, processor, and/or process related communication methodologies.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a multiprocessor, but, in the alternative, the processor may be any conventional processor, controller, microcontroller, or state machine. A processor may also be implemented as a combination of computing devices, e.g., a combination of a DSP and a multiprocessor, a plurality of multiprocessors, one or more multiprocessors in conjunction with a DSP core, or any other such configuration. Alternatively, some steps or methods may be performed by circuitry that is specific to a given function.

In one or more exemplary embodiments, the functions described may be implemented in hardware, software, firmware, or any combination thereof. If implemented in software, the functions may be stored as one or more instructions or code on a non-transitory computer-readable medium or non-transitory processor-readable medium. The steps of a method or algorithm disclosed herein may be embodied in a processor-executable software module, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes CD, laser disc, optical disc, DVD, floppy disk, and blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

What is claimed is:

1. A firearm, comprising:
a cellular telephone transceiver;
a location sensor;
a use sensor; and
a processor coupled to the cellular telephone transceiver, the location sensor, and the use sensor, wherein the processor is configured with processor-executable instructions to perform operations comprising:
acquiring a location of the firearm from the location sensor;
acquiring firearm use data from the use sensor;
using the cellular telephone transceiver to conduct a cellular telephone call with a non-recording telephone device; and
sending at least one of the location of the firearm and the firearm use data to the non-recording telephone device via the cellular telephone call.

2. The firearm of claim 1, further comprising a plurality of additional sensors coupled to the processor, wherein the processor is further configured to send additional data from the plurality of additional sensors to the non-recording telephone device via the cellular telephone call.

3. The firearm of claim 2, wherein the plurality of additional sensors includes a video camera, wherein the processor is further configured to send a video stream to the non-recording telephone device via the cellular telephone call.

4. The firearm of claim 1, further comprising a memory coupled to the processor, wherein the processor is configured with processor-executable instructions to perform operations further comprising:
determining whether determining whether a cellular telephone call can be established; and
storing the acquired use data in the memory in response to determining that a cellular telephone call cannot be established,
wherein using the cellular telephone transceiver to conduct the cellular telephone call with the non-recording telephone device comprises using the cellular telephone transceiver to place a cellular telephone call to the non-recording telephone device in response to determining that a cellular telephone call can be established, and
wherein sending at least one of the location of the firearm and the firearm use data to the non-recording telephone device via the cellular telephone call comprises sending use data stored in the memory via the cellular telephone call to the non-recording telephone device.

5. The firearm of claim 1, wherein the processor is configured with processor-executable instructions to perform operations such that using the cellular telephone transceiver to conduct the cellular telephone call with the non-recording telephone device comprises using the cellular telephone transceiver to receive the cellular telephone call from the non-recording telephone device.

6. The firearm of claim 1, wherein the processor is configured with processor-executable instructions to perform operations further comprising encrypting data before it is sent via the cellular telephone call to the non-recording telephone device.

7. A method implemented on a firearm having a cellular telephone transceiver, a memory, and a processor to enable wiretapping of the firearm, the method comprising:
acquiring data related to the firearm including a location and use of the firearm;
determining whether a cellular telephone call can be established;
storing the acquired data in the memory in response to determining that a cellular telephone call cannot be established; and
placing a cellular telephone call to a non-recording telephone device and transmitting the acquired data and data stored in the memory via the cellular telephone call in response to determining that a cellular telephone call can be established.

8. The method of claim 7, further comprising encrypting the acquired data prior to transmitting the acquired data to the non-recording telephone device via the cellular telephone call.

9. A method of wiretapping a firearm in a system including a firearm configured with sensors and a cellular telephone transceiver, a non-recording telephone device, a cellular telephone network and a CALEA server, the method comprising:
initiating, in the cellular telephone network, a wiretap on the firearm using a telephone number of the firearm cellular telephone transceiver;
acquiring, in the firearm, sensor data related to the firearm including a location and use of the firearm;
determining, in the firearm, whether a cellular telephone call can be established;
storing the acquired sensor data in memory of the firearm in response to determining that a cellular telephone call cannot be established;
placing a cellular telephone call from the firearm cellular telephone transceiver to the non-recording telephone device and transmitting the acquired sensor data and sensor data stored in the memory via the cellular telephone call in response to determining that a cellular telephone call can be established; and
receiving through the wiretap the sensor data sent from the firearm to the non-recording telephone device via the cellular telephone call.

10. The method of claim 9, further comprising:
adding an opaque marker to the cellular telephone call originating from the firearm;
determining whether the cellular telephone call from the firearm is marked for CALEA forwarding; and
transmitting a copy of the sensor data sent from the firearm to the non-recording telephone device via the cellular telephone call to the CALEA server in response to determining that a cellular telephone call is marked for CALEA forwarding; and
ending the cellular telephone call and data transmission to the non-recording telephone device in response to determining that a cellular telephone call is not marked for CALEA forwarding.

11. The method of claim 10, further comprising transmitting the cellular telephone call and the acquired sensor data to a network destination in response to determining that a cellular telephone call is not marked for CALEA forwarding.

12. The method of claim 9, further comprising:
encrypting, in the firearm, the acquired sensor data and the sensor data stored in the memory prior to transmission via the cellular telephone call;
decrypting, in the CALEA server, the sensor data obtained from the firearm via the wiretap; and
storing the sensor data from the firearm.

13. A firearm, comprising:
means for acquiring data related to the firearm including a location and use of the firearm;
means for determining whether a cellular telephone call can be established;
means for storing the acquired data in memory in response to determining that a cellular telephone call cannot be established; and
means for placing a cellular telephone call to a non-recording telephone device and transmitting the acquired data and data stored in the memory via the cellular telephone call in response to determining that a cellular telephone call can be established.

14. The firearm of claim 13, further comprising means for encrypting the acquired data prior to transmitting the acquired data to the non-recording telephone device via the cellular telephone call.

15. A non-transitory processor-readable storage medium having stored thereon processor-executable instructions configured to cause a processor of a firearm to perform operations comprising:
acquiring data related to the firearm including a location and use of the firearm;
determining whether a cellular telephone call can be established;
storing the acquired data in memory in response to determining that a cellular telephone call cannot be established; and
placing a cellular telephone call to a non-recording telephone device and transmitting the acquired data and data stored in the memory via the cellular telephone call in response to determining that a cellular telephone call can be established.

16. The non-transitory processor-readable storage medium of claim 15, wherein the stored processor-executable instructions are configured to cause the processor of the firearm to perform operations further comprising encrypting the acquired data prior to transmitting the acquired data to the non-recording telephone device via the cellular telephone call.

17. A cellular communication system, comprising:
a firearm comprising:
a cellular telephone transceiver;
a location sensor;
a use sensor;
and a firearm processor coupled to the cellular telephone transceiver, the location sensor, and the use sensor, wherein the firearm processor is configured with processor-executable instructions to perform operations comprising:
acquiring sensor data from the location sensor and the use sensor;
determining whether a cellular telephone call can be established;
storing the acquired sensor data in memory of the firearm in response to determining that a cellular telephone call cannot be established; and
placing a cellular telephone call from the firearm cellular telephone transceiver to a non-recording telephone device and transmitting the acquired sensor data and sensor data stored in the memory via the cellular telephone call in response to determining that a cellular telephone call can be established; and
a CALEA server configured with processor-executable instructions to perform operations comprising:
initiating a wiretap on the firearm using a telephone number of the firearm's cellular telephone transceiver; and
receiving through the wiretap the sensor data sent from the firearm to the non-recording telephone device via the cellular telephone call.

18. The cellular communication system of claim 17, further comprising:
a network server configured with processor-executable instructions to perform operations comprising:
adding an opaque marker to the cellular telephone call originating from the firearm;
determining whether the cellular telephone call from the firearm is marked for CALEA forwarding;
transmitting a copy of the sensor data sent from the firearm to the non-recording telephone device via the cellular telephone call to the CALEA server in response to determining that a cellular telephone call is marked for CALEA forwarding; and
ending the cellular telephone call and data transmission to the non-recording telephone device in response to determining that a cellular telephone call is not marked for CALEA forwarding.

19. The cellular communication system of claim 18, wherein the network server is configured with processor-executable instructions to perform operations further comprising transmitting the cellular telephone call and the acquired sensor data to a network destination in response to determining that a cellular telephone call is not marked for CALEA forwarding.

20. The cellular communication system of claim 17, wherein the firearm processor is configured with processor-executable instructions to perform operations further comprising encrypting the acquired sensor data and the sensor data stored in the memory prior to transmission via the cellular telephone call, and
wherein the CALEA server is configured with processor-executable instructions to perform operations further comprising:
decrypting the sensor data obtained from the firearm via the wiretap; and
storing the sensor data from the firearm.

21. A cellular communication system, comprising:
a firearm comprising:
means for acquiring sensor data from a location sensor and a use sensor;
means for determining whether a cellular telephone call can be established;
means for storing the acquired sensor data in memory of the firearm in response to determining that a cellular telephone call cannot be established; and
means for placing a cellular telephone call from the firearm cellular telephone transceiver to a non-recording telephone device and transmitting the acquired sensor data and sensor data stored in the memory via the cellular telephone call in response to determining that a cellular telephone call can be established; and
a CALEA server comprising:
means for initiating a wiretap on the firearm using a telephone number of the firearm's cellular telephone transceiver; and
means for receiving through the wiretap the sensor data sent from the firearm to the non-recording telephone device via the cellular telephone call.

22. The cellular communication system of claim 21, further comprising:
a network server comprising:
means for adding an opaque marker to the cellular telephone call originating from the firearm;
means for determining whether the cellular telephone call from the firearm is marked for CALEA forwarding;
means for transmitting a copy of the sensor data sent from the firearm to the non-recording telephone device via the cellular telephone call to the CALEA server in response to determining that a cellular telephone call is marked for CALEA forwarding; and
means for ending the cellular telephone call and data transmission to the non-recording telephone device in response to determining that a cellular telephone call is not marked for CALEA forwarding.

23. The cellular communication system of claim 22, the network server further comprising means for transmitting the cellular telephone call and the acquired sensor data to a network destination in response to determining that a cellular telephone call is not marked for CALEA forwarding.

24. The cellular communication system of claim 21, wherein:
the firearm further comprises means for encrypting the acquired sensor data and the sensor data stored in the memory prior to transmission via the cellular telephone call; and
the CALEA server further comprises:
means for decrypting the sensor data obtained from the firearm via the wiretap; and
means for storing the sensor data from the firearm.
